(19) United States
(12) Patent Application Publication
(10) Pub. No.: US 2005/0243085 A1
(43) Pub. Date: Nov. 3, 2005

(54) Model 3D construction application program interface

(75) Inventors: Greg D. Schechter, Seattle, WA (US); Gregory D. Swedberg, Bellevue, WA (US); Joseph S. Beda, Seattle, WA (US); Adam M. Smith, Kirkland, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/838,936

(22) Filed: May 3, 2004

(51) Int. Cl. G06T 15/00

(52) U.S. Cl. 345/419

(57) ABSTRACT

An application program interface may be used to construct a three-dimensional (3D) scene of 3D models defined by model 3D objects. The interface has one or more group objects and one or more leaf objects. The group objects contain or collect other group objects and/or leaf objects. The leaf objects may be drawing objects or an illumination object. The group objects may have transform operations to transform objects collected in their group. The drawing objects define instructions to draw 3D models of the 3D scene or instructions to draw 2D images on the 3D models. The illumination object defines the light type and direction illuminating the 3D models in the 3D scene. A method processes a tree hierarchy of computer program objects constructed with objects of the application program interface. The method traverses branches of a 3D scene tree hierarchy of objects to process group objects and leaf objects. The method detects whether the next unprocessed object is a group object of a leaf object. If it is a leaf object, the method detects whether the leaf object is a light object or a drawing 3D object. If the leaf object is a light object, the illumination of the 3D scene is set. If a drawing 3D object is detected, a 3D model is drawn as illuminated by the illumination. The method may also performs a group operation on the group of objects collected by a group object.

### CROSS REFERENCE TO RELATED APPLICATION

The present application is related to U.S. patent application Ser. No. ______, entitled VISUAL AND SCENE GRAPH INTERFACE, filed ______, U.S. patent application Ser. No. ______ entitled DECLARATIVE MECHANISM FOR DEFINING A HIERARCHY OF OBJECTS, filed ______, U.S. patent application Ser. No. ______ entitled INTEGRATION OF THREE DIMENSIONAL SCENE HIERARCHY INTO TWO-DIMENSIONAL COMPOSITING SYSTEM, filed ______, and U.S. patent application Ser. No. ______, entitled TRANSLATING USER INPUT THROUGH TWO-DIMENSIONAL IMAGES INTO THREE-DIMENSIONAL SCENE, filed ______. All of these applications assigned to the Assignee of the present invention and hereby incorporated by reference in their entirety.

### TECHNICAL FIELD

The invention relates generally to the field of computer graphics. More particularly, the invention relates to application program interfaces for three dimensional scene graphics.

### BACKGROUND OF THE INVENTION

The limits of the traditional model of accessing graphics on computer systems are being reached, in part because memory and bus speeds have not kept up with the advancements in main processors and/or graphics processors. In general, the current model for preparing a frame using bitmaps requires too much data processing to keep up with the hardware refresh rate when complex graphics effects are desired. As a result, when complex graphics effects are attempted with conventional graphics models, instead of completing the changes that result in the perceived visual effects in time for the next frame, the changes may be added over different frames, causing results that are visually undesirable.

Further, this problem is aggravated by the introduction of three-dimensional (3D) graphics into the two-dimensional (2D) compositing system to display a mixed scene with 2D images and 3D scenes. Among the problems in implementing such a mixed system is how to define the program objects for 3D models. How should the program objects be organized?

It is with respect to these considerations and others that the present invention has been made.

### SUMMARY OF THE INVENTION

The above and other problems are solved by a computer data structure applied to computer program objects to construct a tree hierarchy to render a three-dimensional (3D) scene of 3D models. The root object in the tree hierarchy collects the objects for the 3D scene. A group object in the tree hierarchy collects other group objects and draw objects in the tree hierarchy and defines group operations operative on the draw objects collected by the group object. A light object in the tree hierarchy defines the illumination to be used in rendering a 3D model in the 3D scene, and one or more draw 3D objects defining operations to draw a 3D model in the 3D scene.

In accordance with other aspects of the invention, the present invention relates to a method for processing a hierarchy of computer program objects for drawing a two dimensional (2D) view of three-dimensional (3D) models rendered by a compositing system. The method traverses branches of a 3D scene tree hierarchy of objects to process group objects and leaf objects. The method detects whether the next unprocessed object is a group object of a leaf object. If it is a leaf object, the method detects whether the leaf object is a light object or a drawing 3D object. If the leaf object is a light object, the illumination of the 3D scene is set. If a drawing 3D object is detected, a 3D model is drawn as illuminated by the illumination. The method may also performs a group operation on the group of objects collected by a group object.

In accordance with yet other aspects, the present invention relates to an application program interface for creating a three-dimensional (3D) scene of 3D models defined by model 3D objects. The interface has one or more group objects and one or more leaf objects. The group objects contain or collect other group objects and/or leaf objects. The leaf objects may be drawing objects or an illumination object. The group objects may have transform operations to transform objects collected in their group. The drawing objects define instructions to draw 3D models of the 3D scene or instructions to draw 2D images on the 3D models. The illumination object defines the light type and direction illuminating the 3D models in the 3D scene.

The invention may be implemented as a computer process, a computing system or as an article of manufacture such as a computer program product or computer readable media. The computer readable media may be a computer storage media readable by a computer system and encoding a computer program of instructions for executing a computer process. The computer readable media may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates a data structure of related objects in the model 3D construction API according to one embodiment of the present invention.

FIG. 2 illustrates an example of a suitable computing system environment on which embodiments of the invention may be implemented.

FIG. 3 is a block diagram generally representing a graphics layer architecture into which the present invention may be incorporated.

FIG. 4 is a representation of a scene graph of visuals and associated components for processing the scene graph such as by traversing the scene graph to provide graphics commands and other data.

FIG. 5 is a representation of a scene graph of validation visuals, drawing visuals and associated drawing primitives constructed.

FIG. 6 illustrates an exemplary Model3D tree hierarchy for rendering a motorcycle as a 3D scene.

FIG. 7 shows the operation flow for processing a 3D scene tree hierarchy such as that shown in FIG. 6.

FIG. 8 shows a data structure of related objects for Transform3D objects contained in a Model 3D group object.

FIG. 9 shows a data structure of related objects for a light object in a Model3D API.

### DETAILED DESCRIPTION OF THE INVENTION

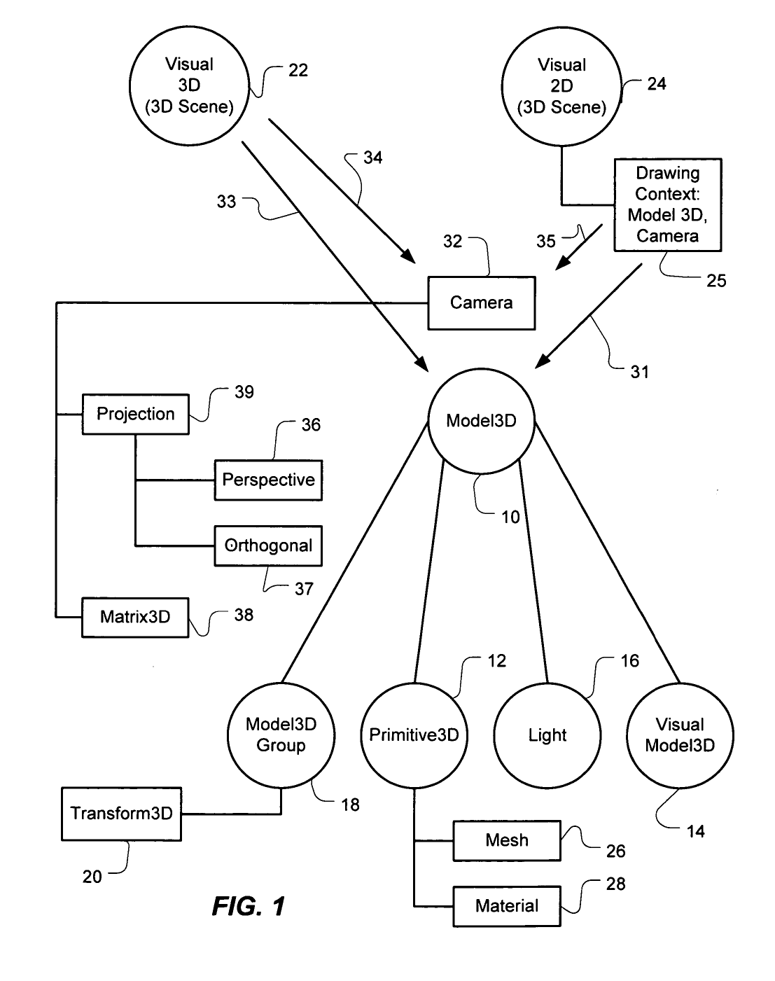

FIG. 1 illustrates an architecture of computer program objects for implementing Model 3D API in accordance with one embodiment of the invention. The Model3D object 10 is a root or abstract object. There are four possible model 3D objects that are children related to root object. The three objects, Primitive3D object 12, Visual Model3D object 14, and Light object 16 are leaf objects in this architecture. Model3D group object 20 is a collecting node in the tree for leaf objects or other group objects and also contains Transform3D object 18. Transform 3D object has a hierarchy of transform objects associated with it.

Primitive 3D object contains a mesh information 26 and material information 28 that also may reference or point to hierarchies of objects to assist the definition of the 3D model being drawn by Primitive3D object 12. Visual Model3D object 14 defines a 2D image for incorporation into the 3D scene. Light object 16 defines the illumination for the 3D scene and has a hierarchy of objects for defining various lighting conditions. All of these objects are defined hereinafter in the Model3D API Definitions.

The objects of FIG. 1 are used to construct a model 3D scene tree, i.e. a tree hierarchy of model 3D objects for rendering a 3D scene. The 3D scene tree is entered at the Model3D root object 10 from either a visual 3D object 22 or a visual 2D object having drawing context 25. Visual 3D object 22 and the drawing context 25 of Visual 2D object 24 contain pointers that point to the Model3D root object 10 and a camera object 32. Pointer 33 of the visual 3D object points to the model 3D root object 10. Pointer 34 of the visual 3D object points to the camera object 32. Pointer 31 contained in the drawing context 25 of the visual 2D object 24 points to the model 3D root object 10. Pointer 35 contained in the drawing context 25 of the visual 2D object 24 points to the camera object 32.

Camera object 32 defines the view point or eye point location of the camera viewing the 3D scene. The camera object 32 has a hierarchy of camera objects including projection camera object 39, perspective camera object 36, orthogonal camera object 37 and Matrix3D camera object 38. Each of these camera objects are defined hereinafter in the Model3D API Definitions.

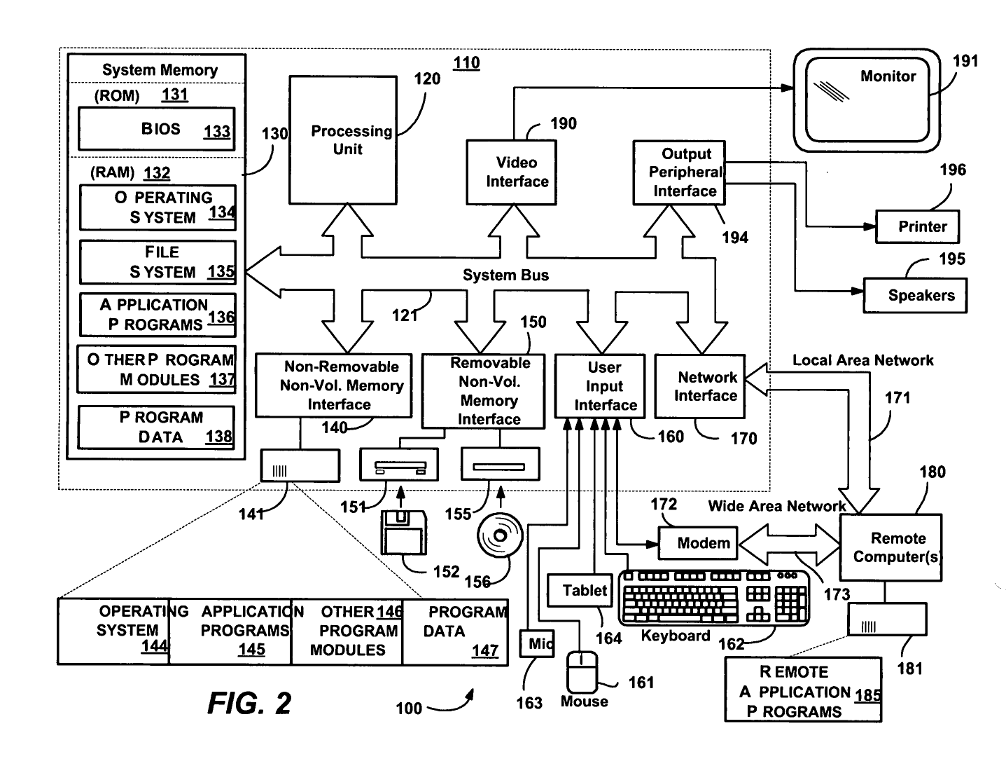

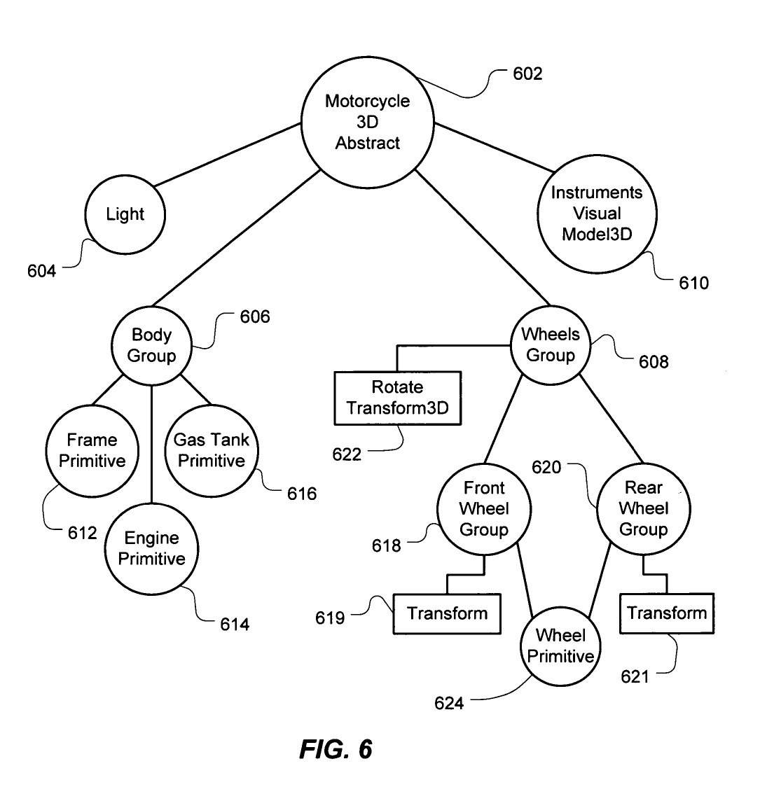

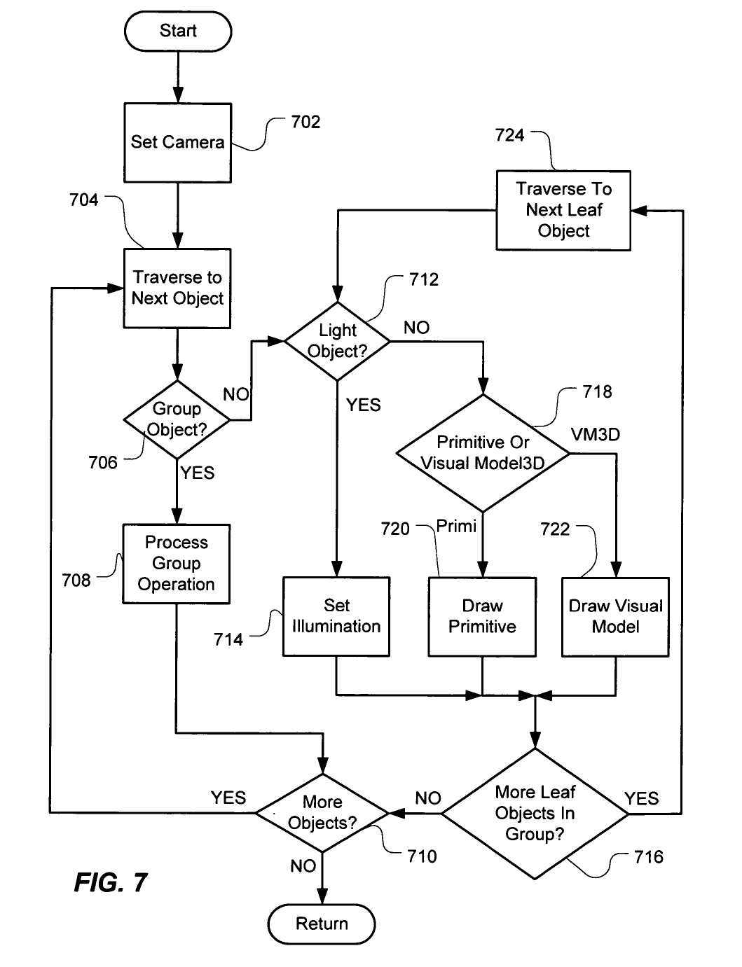

FIG. 6 described hereinafter is an example of a 3D scene tree constructed using the model 3D objects of FIG. 1 as building blocks. The operational flow for rendering a 3D scene from FIG. 6 is described hereinafter in reference to FIG. 7. An exemplary operative hardware and software environment for implementing the invention will now be described with reference to FIGS. 2 through 5.

Exemplary Operating Environment

FIG. 2 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Accelerated Graphics Port (AGP) bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136 and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 2, provide storage of computer-readable instructions, data structures, program modules and other data for the computer 110. In FIG. 2, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet (electronic digitizer) 164, a microphone 163, a keyboard 162 and pointing device 161, commonly referred to as mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel 193 or the like that can input digitized input such as handwriting into the computer system 110 via an interface, such as a touch-screen interface 192. Note that the monitor and/or touch screen panel can be physically coupled to a housing in which the computing device 110 is incorporated, such as in a tablet-type personal computer, wherein the touch screen panel 193 essentially serves as the tablet 164. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Software Environment for Processing the Visual Tree Hierarchy

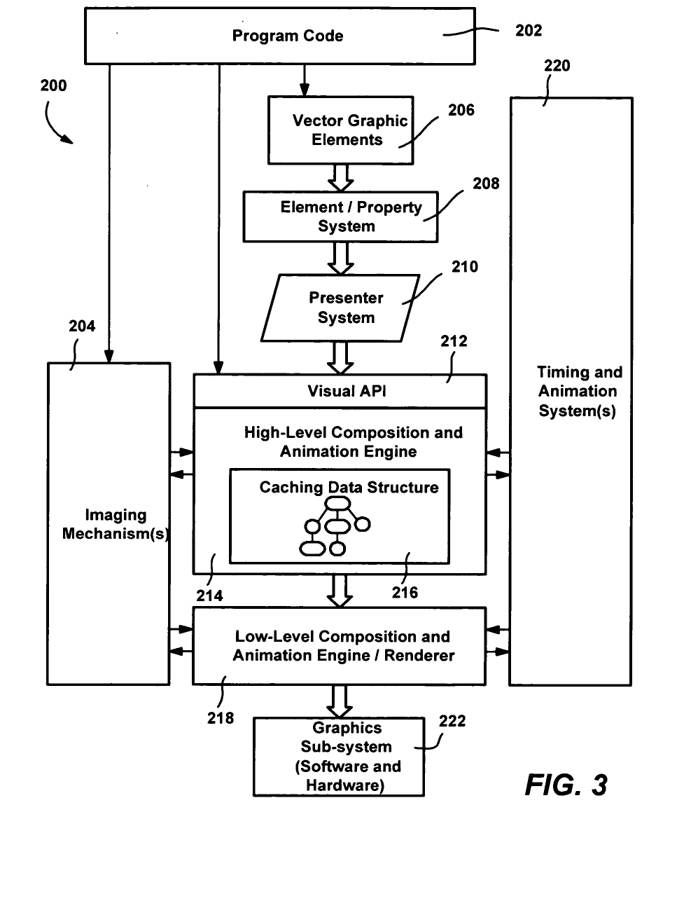

FIG. 3 represents a general, layered architecture 200 in which visual trees may be processed. As represented in FIG. 3, program code 202 (e.g., an application program or operating system component or the like) may be developed to output graphics data in one or more various ways, including via imaging 204, via vector graphic elements 206, and/or via function/method calls placed directly to a visual application programming interface (API) layer 212, in accordance with an aspect of the present invention. In general, imaging 204 provides the program code 202 with a mechanism for loading, editing and saving images, e.g., bitmaps. As described below, these images may be used by other parts of the system, and there is also a way to use the primitive drawing code to draw to an image directly. Vector graphics elements 206 provide another way to draw graphics, consistent with the rest of the object model (described below). Vector graphic elements 206 may be created via a markup language, which an element/property system 208 and presenter system 210 interprets to make appropriate calls to the visual API layer 212.

The graphics layer architecture 200 includes a high-level composition and animation engine 214, which includes or is otherwise associated with a caching data structure 216. The caching data structure 216 contains a scene graph comprising hierarchically-arranged objects that are managed according to a defined object model, as described below. In general, the visual API layer 212 provides the program code 202 (and the presenter system 210) with an interface to the caching data structure 216, including the ability to create objects, open and close objects to provide data to them, and so forth. In other words, the high-level composition and animation engine 214 exposes a unified media API layer 212 by which developers may express intentions about graphics and media to display graphics information, and provide an underlying platform with enough information such that the platform can optimize the use of the hardware for the program code. For example, the underlying platform will be responsible for caching, resource negotiation and media integration.

The high-level composition and animation engine 214 passes an instruction stream and possibly other data (e.g., pointers to bitmaps) to a fast, low-level compositing and animation engine 218. As used herein, the terms “high-level” and “low-level” are similar to those used in other computing scenarios, wherein in general, the lower a software component is relative to higher components, the closer that component is to the hardware. Thus, for example, graphics information sent from the high-level composition and animation engine 214 may be received at the low-level compositing and animation engine 218, where the information is used to send graphics data to the graphics subsystem including the hardware 222.

The high-level composition and animation engine 214 in conjunction with the program code 202 builds a scene graph to represent a graphics scene provided by the program code 202. For example, each item to be drawn may be loaded with drawing instructions, which the system can cache in the scene graph data structure 216. As will be described below, there are a number of various ways to specify this data structure 216, and what is drawn. Further, the high-level composition and animation engine 214 integrates with timing and animation systems 220 to provide declarative (or other) animation control (e.g., animation intervals) and timing control. Note that the animation system allows animate values to be passed essentially anywhere in the system, including, for example, at the element property level 208, inside of the visual API layer 212, and in any of the other resources. The timing system is exposed at the element and visual levels.

The low-level compositing and animation engine 218 manages the composing, animating and rendering of the scene, which is then provided to the graphics subsystem 222. The low-level engine 218 composes the renderings for the scenes of multiple applications, and with rendering components, implements the actual rendering of graphics to the screen. Note, however, that at times it may be necessary and/or advantageous for some of the rendering to happen at higher levels. For example, while the lower layers service requests from multiple applications, the higher layers are instantiated on a per-application basis, whereby is possible via the imaging mechanisms 204 to perform time-consuming or application-specific rendering at higher levels, and pass references to a bitmap to the lower layers.

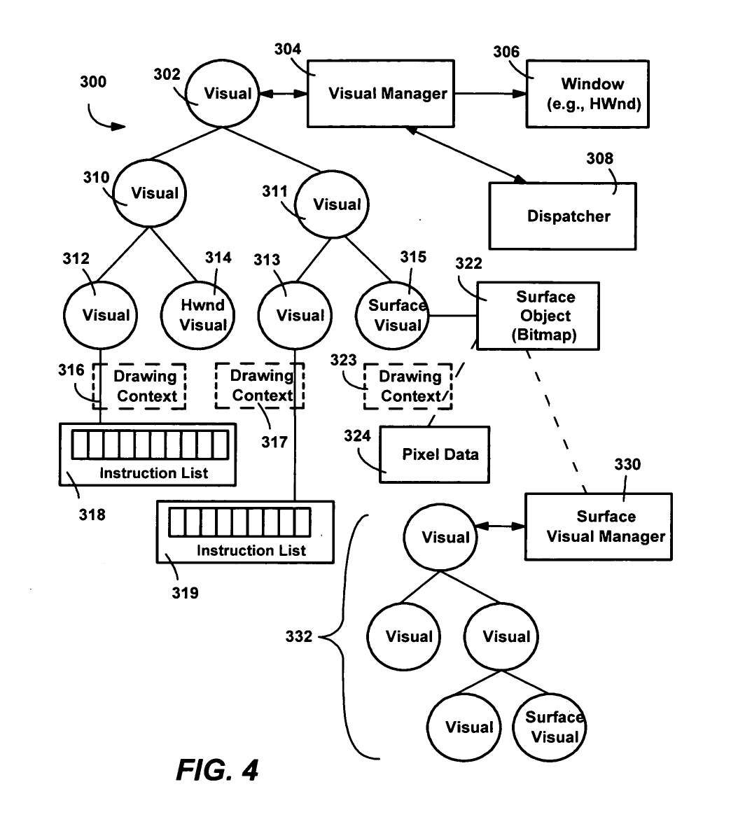

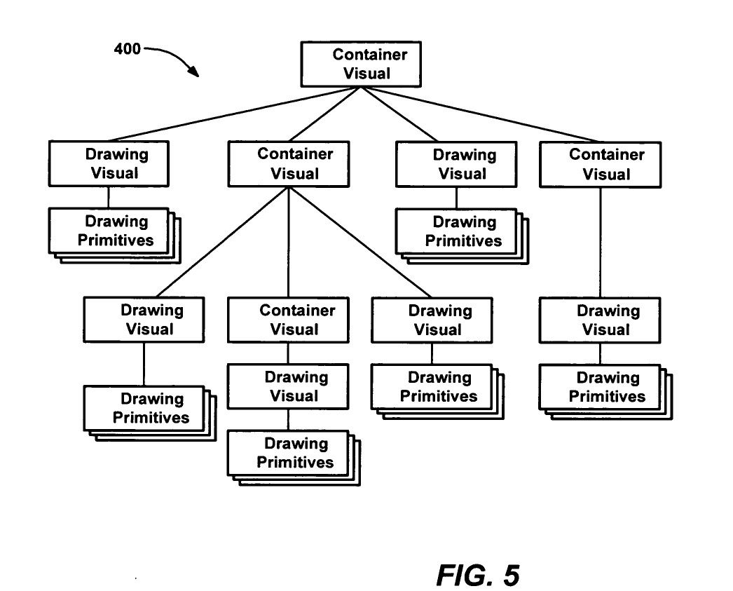

FIGS. 4 and 5 show example scene graphs 300 and 400, respectively, including a base object referred to as a visual. In general, a visual comprises an object that represents a virtual surface to the user and has a visual representation on the display. As represented in FIG. 4, a top-level (or root) visual 302 is connected to a visual manager object 304, which also has a relationship (e.g., via a handle) with a window (HWnd) 306 or similar unit in which graphic data is output for the program code. The VisualManager 304 manages the drawing of the top-level visual (and any children of that visual) to that window 306. To draw, the visual manager 304 processes (e.g., traverses or transmits) the scene graph as scheduled by a dispatcher 308, and provides graphics instructions and other data to the low level component 218 (FIG. 3) for its corresponding window 306. The scene graph processing will ordinarily be scheduled by the dispatcher 308 at a rate that is relatively slower than the refresh rate of the lower-level component 218 and/or graphics subsystem 222. FIG. 4 shows a number of child visuals 310-315 arranged hierarchically below the top-level (root) visual 302, some of which are represented as having been populated via drawing contexts 316, 317 (shown as dashed boxes to represent their temporary nature) with associated instruction lists 318 and 319, respectively, e.g., containing drawing primitives and other visuals. The visuals may also contain other property information, as shown in the following example visual class:

public abstract class Visual : VisualComponent
{

public Transform Transform { get; set; }
public float Opacity { get; set; }
public BlendMode BlendMode { get; set; }
public Geometry Clip { get; set; }
public bool Show { get; set; }
public HitTestResult HitTest (Point point);
public bool IsDescendant (Visual visual);
public static Point TransformToDescendant(

Visual reference,
Visual descendant,
Point point);

public static Point TransformFromDescendant(

Visual reference,
Visual descendant,
Point point);

public Rect CalculateBounds( ); // Loose bounds
public Rect CalculateTightBounds( ); //
public bool HitTestable { get; set; }
public bool HitTestIgnoreChildren { get; set; }
public bool HitTestFinal { get; set; }

}

As can be seen, visuals offer services by providing transform, clip, opacity and possibly other properties that can be set, and/or read via a get method. In addition, the visual has flags controlling how it participates in hit testing. A Show property is used to show/hide the visual, e.g., when false the visual is invisible, otherwise the visual is visible.

A transformation, set by the transform property, defines the coordinate system for the sub-graph of a visual. The coordinate system before the transformation is called pre-transform coordinate system, the one after the transform is called post-transform coordinate system, that is, a visual with a transformation is equivalent to a visual with a transformation node as a parent. A more complete description of the visual tree and the compositing system is included in the related patent application entitled VISUAL AND SCENE GRAPH INTERFACE cross-referenced above.

Model 3D API Processing

FIG. 6 shows an exemplary 3D scene tree hierarchy constructed with the model 3D API for rendering a two-dimensional view of a 3D scene—in this case a motorcycle. The tree illustrates use of the various structural data objects in the model 3D API. The abstract or root node of the tree for the motorcycle is object 602. The abstract object has four children—light object 604, body group object 606, wheels group object 608 and instruments Visual Model3D object 610.

The body group object has three children that make up the body of the motorcycle; they are the frame primitive object 612, engine primitive object 614 and gas tank primitive object 616. Each of these primitive objects will draw the motorcycle body elements named for the object. The wheels group object 608 collects the front wheel group object 618 and the rear wheel group object 620. Wheel primitive object 624 draws a 3D model of a wheel. Front wheel group object 618 has a 3D transform 619 to transform the wheel to be drawn by wheel primitive object 624 into a front wheel. Likewise, rear wheel group object 620 has a 3D transform 621 to transform the wheel to be drawn by wheel primitive object 624 into a rear wheel. In addition there is a 3D transform 622 that is contained in the wheels group object 608. The transform object 622 may for example transform the execution of the front primitive object 618 and the rear primitive object 620 to rotate the wheels for an animation effect.

This exemplary tree of model 3D objects may be processed by the operational flow of logical operations illustrated in FIG. 7. The logical operations of the embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

In FIG. 7, the operation flow begins with set camera view operation 702. The camera location is provided by the visual 3D object 22 (FIG. 1). Traverse operation 704 walks down a branch of the tree until it reaches an object. Normally, the tree is walked down and from left to right. Group test operation 706 detects whether the object is a group object or a leaf object. If it is a group object, the operation flow branches to process group object operation 708. Operation 708 will process any group operation contained in the object. Transform 3D operations are examples of group operations. More objects test operation 710 detects whether there are more objects in the tree and returns the flow to traverse operation 704 if there is at least another object.

If the next object is a leaf object, the operation flow branches from group test operation 706 to light object test operation 712. If the leaf object is a light object, the operation flow then branches YES from light object test operation 712 to set illumination operation 714. Operation 714 processes the light object to set the illumination for the 3D scene. The operation flow then proceeds to more leaf objects test operation 716. If the leaf object is not a light object, the operation flow passes to primitive/visual model object test operation 718. If the leaf object is a primitive object, the operation flow branches to draw primitive operation 720 and thereafter to more leaf objects test operation 716. The draw primitive operation 720 will draw the 3D model specified by the primitive object. If the leaf object is a Visual Model3D object, the operation flow branches to draw visual model operation 722 and thereafter to more leaf objects test operation 716. The draw visual model operation 722 will draw the visual model specified by the Visual Model3D object.

More leaf objects test operation 716 branches the operation flow to leaf traverse operation 724 if there are more leaf objects in the group. Traverse operation 724 walks the tree to the next child under the same group object. Light object test operation 712 and primitive/visual model test operation 718 detect whether the next leaf is a light object, a primitive object or a visual modle object. The detected leaf object is processed as described above repeats. After all the leaf objects, that are children of the same group object, are processed, the operation flow branches NO from test operation 716 to more objects test operation 710. If there are more objects to process, the operation flow returns to traverse operation 704. If not, the model 3D tree has been processed, and the operation flow passes through return 726 back to the caller of the processing of the 3D scene.

In the example of the 3D scene tree in FIG. 6, the first object reached is the light object. As defined in the Model 3D API Definitions below, the light object specifies the type of light illuminating the 3D scene. When the first leaf node, the light object, is reached group object test operation 706 detects that the object is a leaf object, and the operation flow branches to light object test operation 708. The light object 604 is detected by test operation 708, and the set illumination operation 714 is performed by the light object to set the illumination of the 3D scene. The flow then returns through more leaf objects test operation 716 and more objects test operation 710 to traverse operation 704.

Traverse operation 704 walks down the tree in FIG. 6 to body group object 606. Group test operation now branches the flow to process group operation 708 to peform any operations in group object 606 that are for the body group. Then the flow again returns to traverse operation 704, and the traverse operation will walk down the branch from body group object 606 to the frame primitive object 602. The frame primitive object 602 will be processed as described above by the draw primitive operation 720 after the operation flow branches through test operations 706, 712 and 718. The engine primitive object 614 and the gas tank primitive object 616 will be processed in turn as the operation flow loops back through more leaf objects test 716, traverse to next leaf object operation 724 and test operations 712 and 718. When all the leafs from the body group object node 606 are processed, the traverse operation 704 will walk the tree to wheels group object 608.

The processing of the wheels group object and its children is the same as the processing of the body group object and its children except that the wheels body group object 608 contains a Transform3D object 622. The Transform3D object might be used to animate the wheels of the motorcycle image. When processing the wheels body group object 608, the operation flow will branch from group objects test operation 706 to process group operation 708 upon detecting the Transform3D object 622. Process group operation 708 will execute the transform operations of object 622 to rotate the wheels of the motorcycle.

The last object in the exemplary 3D scene tree of FIG. 6 to be processed is the instruments Visual Model3D object 610. After the wheels group branch of the tree has been processed, traverse operation 704 will walk the tree to instruments object 610. In the operation flow of FIG. 7, the flow passes to draw visual model operation 722 through test operations 706, 712 and 718 when detecting the instruments Visual Model3D object 610. Draw visual model operation 722 draws the visual model specified by object 610. This completes the processing of the 3D scene tree in FIG. 6 by the operations of FIG. 7.

### Model 3D API Definitions

The following API's are defined for Model 3D objects.

A Visual3D object such as object 22 in FIG. 1 is essentially just:
A set of 3D (rendering instructions/scene graph/metafile) including lights
A camera to define the 2D projection of that scene,
A rectangular 2D viewport in local coordinate space for mapping the projection to, and
Other ambient parameters like antialiasing switches, fog switches, etc.
   Rendering to 3D

Like 2D, rendering happens via a DrawingContext where calls get made. For instance, in 2D, one says:

DrawingContext ctx = ...;
ctx.DrawRectangle(...);
ctx.PushTransform(...);
ctx.DrawGeometry(...);
ctx.PushTransform(...);
ctx.DrawEllipse(...);
ctx.Pop( );
ctx.Pop( );

For consistency with 2D, a similar model in 3D looks like:

DrawingContext3 ctx = ...;
ctx.DrawMesh(mesh, material);
ctx.PushTransform(transform3);
ctx.DrawMesh(...);
ctx.PushTransform(...);
ctx.DrawMesh(...);
ctx.Pop( );
ctx.Pop( );

Note that this model of rendering works well for both a retained mode 3D visual (where the “instructions” are simply saved), and an immediate mode 3D visual (where the rendering happens directly, and a camera needs to be established up front). In fact, in the retained mode case, what happens internally is a 3D modeling hierarchy is getting built up and retained. Alternatively, in the immediate mode case, no such thing is happening, and instructions are being issued directly, and a context stack (for transforms, for example) is being maintained.

Sample Code

Here's an example to show the flavor of programming with the 3D Visual API. This example simply created a Visual3D, grabs a drawing context to render into, renders primitives and lights into it, sets a camera, and adds the visual to the visual children of a control.

// Create a 3D visual
visual3D visual3 = new visual3D( );
// Render into it
using (Drawing3DContext ctx = visual3.Models.RenderOpen( ))
{

// Render meshes and lights into the geometry
ctx.DrawMesh(mesh, material);
ctx.PushTransform(transform3);
ctx.DrawMesh(...);
ctx.PushTransform(secondTransform3);
ctx.AddLight(...);
ctx.DrawMesh(...);
ctx.Pop( );
ctx.Pop( );

}
// Establish ambient properties on the visual
visual3.Camera = new PerspectiveCamera(...);
// Add it to the compositing children of some control called myControl
VisualCollection children =

VisualHelper.GetVisualChildren(myControl); // or something

children.Add(visual3);

Modeling APIs

The above shows an “imperative rendering” style of usage where drawing “instructions” are issued to the context. This is not a declarative usage, and, when we get to the Element/Markup section, we'll see that this imperative approach is not appropriate for declarative markup.

Therefore, there is a declarative way of building up and using 3D “resources” like exists in 2D with Brushes, Pens, Geometry, Paths, etc.

To that end, a number of types are introduced that allow users to construct what goes into the 3D instruction stream, and the constructed object can be set into a Visual3D instead of using the context.

For example, the above Drawing3DContext-based sample code could be rewritten as:

// Create a 3D visual
Visual3d visual3 = new Visual3D( );
visual3.Models.Add(new MeshPrimitive3D(mesh, material));
Model3DGroup innerGroup1 = new Model3DGroup( );
innerGroup1.Transform = transform3;
innerGroup1.Children.Add(new MeshPrimitive3D(mesh, material));
Model3DGroup innerGroup2 = new Model3DGroup( );
innerGroup2.Transform = secondTransform3;
innerGroup2.Children.Add(new Light(...));
innerGroup2.Children.Add(new MeshPrimitive3D(...));
innerGroup1.Children.Add(innerGroup2);
visual3.Models.Add(innerGroup1);
// Everything else is the same as before...
// Establish ambient properties on the visual
visual3.Camera = new PerspectiveCamera(...);
// Add it to the compositing children of some control called myControl
VisualCollection children =

VisualHelper.GetVisualChildren(myControl); // or something

children.Add(visual3);

Here, we very much are building a model, and then assigning it into the Visual3D. PushTransform/Pop pairs are replaced by construction of a Model3DGroup which itself has a transform and Models beneath it.

Again, the point of offering both this modeling approach and the imperative context-based approach is not to be confusing, but rather to provide a solution for:
Element-level declarative markup
Visual enumeration
Scene graph effects
Modifiability of visual contents

Modeling Class Hierarchy

FIG. 1 illustrates the modeling class hierarchy. The root of the modeling class tree is Model3D, which represents a three-dimensional model that can be attached to a Visual3D. Ultimately, lights, meshes, .X file streams (so it can come from a file, a resource, memory, etc), groups of models, and 3D-positioned 2D visuals are all models. Thus, we have the following hierarchy
Model3D
   Model3DGroup—container to treat a group of Model3Ds as one unit
   Primitive3D
      MeshPrimitive3D(mesh, material, hitTestID)
      ImportedPrimitive3D(stream, hitTestID) (for .x files)
   Light
      AmbientLight
      SpecularLight
         DirectionalLight
         PointLight
            SpotLight
   VisualModel3D—has a Visual and a Point3 and a hitTestID

The Model3D class itself supports the following operations:
Get 3D bounding box.
Get and set the Transform of the Model3D
Get and set other “node” level properties, like shading mode.
Get and set the hitTestObject
   Visual API Specifications

First, note that while it's not explicitly listed for each type, every one of these types has the following methods (shown here for Vector3D, but applicable to every other one as well)

public static bool operator == (Vector3D vector1, Vector3D vector2)
public static bool Equals(Vector3D vector1, Vector3D vector2)
public static bool operator != (Vector3D vector1, Vector3D vector2)
public override bool Equals(object o)
public override int GetHashCode( )
public override string ToString( )

Also, every type that derives from Changeable (either directly or indirectly) will need to have a “public new MyType Copy( )” method on it.

Primitive Types

These primitive types simply exist in support of the other types described in this section.

Point3D

Point3D is a straightforward analog to a 2D Point type System.Windows.Point.

public struct System.Windows.Media3D.Point3D
{

public Point3D( ); // initializes to 0,0,0
public Point3D(double x, double y, double z);
public double X { get; set; }
public double Y { get; set; }
public double Z { get; set; }
public void offset(double dx, double dy, double dz);
public static Point3D operator +(Point3D point, Vector3D
vector);
public static Point3D operator −(Point3D point, Vector3D
vector);
public static Vector3D operator −(Point3D point1, Point3D
point2);
public static Point3D operator *(Point3D point, Matrix3D matrix);
public static Point3D operator *(Point3D point, Transform3D
transform);
public static explicit operator Vector3D(Point3D point);
// Explicit promotion of a 3D point to a 4D point, W coord
becomes 1.
public static explicit operator Point4D(Point3D point);

}

TypeConverter Specification

coordinate:

double-number-representation

comma-wsp:

one comma with any amount of whitespace before or after

coordinate-triple:

(coordinate comma-wsp){2} coordinate

point3D:

coordinate-triple

Vector3D

Vector3D is a straightforward analog to the 2D Vector type System.Windows.Vector.

public struct System.Windows.Media3D.Vector3D
{

public Vector3D( ); // initializes to 0,0,0
public Vector3D(double x, double y, double z);
public double X { get; set; }
public double Y { get; set; }
public double Z { get; set; }
public double Length { get; }
public double LengthSquared { get; }
public void Normalize( ); // make the Vector3D unit length
public static Vector3D operator −(Vector3D vector);
public static Vector3D operator +(Vector3D vector1,
Vector3D vector2);
public static Vector3D operator −(Vector3D vector1,
Vector3D vector2);
public static Point3D operator +(Vector3D vector,
Point3D point);
public static Point3D operator −(Vector3D vector,
Point3D point);
public static Vector3D operator *(Vector3D vector,
double scalar);
public static Vector3D operator *(double scalar,
Vector3D vector);
public static Vector3D operator /(Vector3D vector,
double scalar);
public static Vector3D operator *(Vector3D vector,
Matrix3D matrix);
public static Vector3D operator *(Vector3D vector,
Transform3D transform);
// return the dot product: vector1.x*vector2.x +
vector1.Y*vector2.Y
public static double DotProduct(Vector3D vector1,
Vector3D vector2);
// return a vector perpendicular to the two input
vectors by computing
// the cross product.
public static Vector3D CrossProduct(Vector3D vector1,
Vector3D vector2);
// Return the angle required to rotate v1 into v2,
in degrees
// This will return a value between [0, 180]
degrees
// (Note that this is slightly different from the
Vector member
// function of the same name. Signed angles do not
extend to 3D.)
public static double AngleBetween(Vector3D vector1,
Vector3D vector2);
public static explicit operator Point3D(Vector3D vector);}
// Explicit promotion of a 3D vector to a 4D point, W
coord becomes 0.
public static explicit operator Point4D(Vector3D point);

TypeConverter Specification

point3D:

coordinate-triple

Point4D

Point4D adds in a fourth, w, component to a 3D point, and is used for transforming through non-affine Matrix3D's. There is no Vector4D, as the ‘w’ component of 1 translates to a Point3D, and a ‘w’ component of 0 translates to a Vector3D.

public struct System.Windows.Media3D.Point4D
{

public Point4D( ); // initializes to 0,0,0,0
public Point4D(double x, double y, double z, double w);
public double X { get; set; }
public double Y { get; set; }
public double Z { get; set; }
public double W { get; set; }
public static Point4D operator −(Point4D point1,
Point4D point2);
public static Point4D operator +(Point4D point1,
Point4D point2);
public static Point4D operator *(double scalar, Point4D point);
public static Point4D operator *(Point4D point, double scalar);
public static Point4D operator *(Point4D point, Matrix3D matrix);
public static Point4D operator *(Point4D point, Transform3D
transform);

}

TypeConverter Specification

point4D:

coordinate-quad

Quaternion

Quaternions are distinctly 3D entities that represent rotation in three dimensions. Their power comes in being able to interpolate (and thus animate) between quaternions to achieve a smooth, reliable interpolation. The particular interpolation mechanism is known as Spherical Linear Interpolation (or SLERP).

Quaternions can either be constructed from direct specification of their components (x,y,z,w), or as an axis/angle representation. The first representation may result in unnormalized quaternions, for which certain operations don't make sense (for instance, extracting an axis and an angle).

The components of a Quaternion cannot be set once the Quaternion is constructed, since there's potential ambiguity in doing so. (What does it mean to set the Angle on a non-normalized Quaternion, for instance?)

public struct System.Windows.Media3D.Quaternion
{

public Quaternion( ); // initializes to 0,0,0,0
// Non-normalized quaternions are allowed
public Quaternion(double x, double y, double z, double w);
// allow construction through axis and angle
public Quaternion(Vector3D axisOfRotation, double angleInDegrees);
// fundamental Quaternion components
public double X { get; }
public double Y { get; }
public double Z { get; }
public double W { get; }
// axis/angle access, will raise an exception if the quaternion
// is not normalized.
public Vector3D Axis { get; }
public double Angle { get; } // in degrees, just
like everything else
// Magnitude of 1? Only normalized quaternions can be used in
// RotateTransform3D's.
public bool IsNormalized { get; }
public Quaternion Conjugate( ); // return conjugate of the quaternion
public Quaternion Inverse( ); // return the inverse of the quaternion
public Quaternion Normalize( ); // return a normalized quaternion
public static Quaternion operator +(Quaternion left,
Quaternion right);
public static Quaternion operator −(Quaternion left,
Quaternion right);
public static Quaternion operator *(Quaternion left, Quaternion right);
// smoothly interpolate between two quaternions
public static Quaternion Slerp(Quaternion left, Quaternion
right, double t);

}

TypeConverter Specification

quaternion:

| | |
|---|---|
| coordinate-quad \| | // x,y,z,w representation |
| “(“ coordinate-triple “)” coordinate | // axis,angle representation |

Matrix3D

Matrix3D is the 3D analog to System.Windows.Matrix. Like Matrix, most APIs don't take Matrix3D, but rather Transform3D, which supports animation in a deep way.

$$[ \begin{matrix}m11 & m12 & m13 & m14 \\ m21 & m22 & m23 & m24 \\ m31 & m32 & m33 & m34 \\ offsetX & offsetY & offsetZ & m44\end{matrix} ]$$

When a matrix is multiplied with a point, it transforms that point from the new coordinate system to the previous coordinate system.

Transforms can be nested to any level. Whenever a new transform is applied it is the same as pre-multiplying it onto the current transform matrix:

public struct System.Windows.Media3D.Matrix3D
{

// Construction and setting
public Matrix( ); // defaults to identity
public Matrix(

double m11, double m12, double m13, double m14,
double m21, double m22, double m23, double m24,
double m31, double m32, double m33, double m34,
double offsetX, double offsetY, double offsetZ,
double m44);

// Identity
public static Matrix3D Identity { get; }
public void SetIdentity( );
public bool isIdentity { get; }
// Math operations
public void Prepend(Matrix3D matrix); // “this”
becomes: matrix * this
public void Append(Matrix3D matrix); // “this”
becomes: this * matrix
// Rotations - Quaternion versions. If you want axis/angle
rotation,
// build the quaternion out of axis/angle.
public void Rotate(Quaternion quaternion);
public void RotatePrepend(Quaternion quaternion);
public void RotateAt(Quaternion quaternion, Point3D center);
public void RotateAtPrepend(Quaternion quaternion, Point3D
center);
public void Scale(Vector3D scalingVector);
public void ScalePrepend(Vector3D scalingVector);
public void ScaleAt(Vector3D scalingVector, Point3D point);
public void ScaleAtPrepend(Vector3D scalingVector, Point3D
point);
public void Skew(Vector3D skewVector); // Appends a skew,
in degrees
public void SkewPrepend(Vector3D skewVector);
public void SkewAt(Vector3D skewVector, Point3D point);
public void SkewAtPrepend(Vector3D skewVector, Point3D point);
public void Translate(Vector3D offset); // Appends a translation
public void TranslatePrepend(Vector3D offset); // Prepends
a translation
public static Matrix3D operator * (Matrix3D matrix1, Matrix3D
matrix2);
// Transformation services. Those that operate on Vector3D
and Point3D
// raise an exception if isAffine == false.
public Point3D Transform(Point3D point);
public void Transform(Point3D[ ] points);
public Point4D Transform(Point4D point);
public void Transform(Point4D[ ] points);
// Since this is a vector ignores the offset parts of the matrix
public Vector3D Transform(Vector3D vector);
public void Transform(Vector3D[ ] vectors);
// Characteristics of the matrix
public bool IsAffine { get; } // true
if m{1,2,3}4 == 0, m44 == 1.
public double Determinant { get; }
public bool HasInverse { get; }
public Matrix3D Inverse { get; }
// Throws InvalidOperationException if
!HasInverse
// individual members
public double M11 { get; set; }
public double M12 { get; set; }
public double M13 { get; set; }
public double M14 { get; set; }
public double M21 { get; set; }
public double M22 { get; set; }
public double M23 { get; set; }
public double M24 { get; set; }
public double M31 { get; set; }
public double M32 { get; set; }
public double M33 { get; set; }
public double m34 { get; set; }
public double OffsetX { get; set; }
public double OffsetY { get; set; }
public double OffsetZ { get; set; }
public double M44 { get; set; }

};

TypeConverter Specification

matrix3D:

( coordinate comma-wsp ){15} coordinate | “Identity”

Transform3D Class Hierarchy

Transform3D, like the 2D Transform, is an abstract base class with concrete subclasses representing specific types of 3D transformation.

Specific subclasses of Transform3D are also where animation comes in.

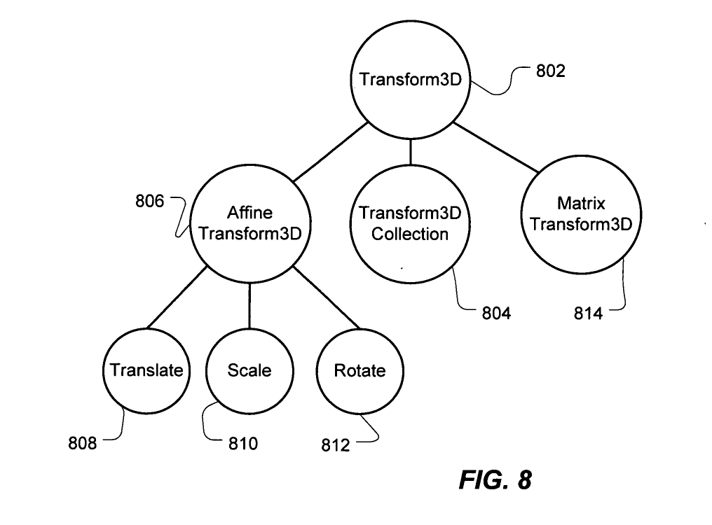

The overall hierarchy of Transform3D looks like this and is shown in FIG. 8.

Transform3D
Transform3DCollection
AffineTransform3D
   TranslateTransform3D
   ScaleTransform3D
   RotateTransform3D
MatrixTransform3D

Transform3D

Root Transform3D object 802 has some interesting static methods for constructing specific classes of Transform. Note that it does not expose a Matrix3D representation, as this Transform may be broader than that.

public abstract class System.Windows.Media.Media3D.Transform3D :
Changeable
{

internal Transform3D( );
public new Transform3D Copy( );
// static helpers for creating common transforms
public static MatrixTransform3D CreateMatrixTransform(Matrix3D
matrix);
public static TranslateTransform3D CreateTranslation(Vector3D
translation);
public static RotateTransform3D CreateRotation(Vector3D axis,
double angle);
public static RotateTransform3D CreateRotation(Vector3D axis,
double angle,
Point3D rotationCenter);
public static RotateTransform3D CreateRotation(Quaternion
quaternion);
public static RotateTransform3D CreateRotation(Quaternion
quaternion,
Point3D rotationCenter);
public static ScaleTransform3D CreateScale(Vector3D scaleVector);
public static ScaleTransform3D CreateScale(Vector3D scaleVector,
Point3D scaleCenter);
public static Transform3D Identity { get; }
// Instance members
public bool isAffine { get; }
public Point3D Transform(Point3D point);
public Vector3D Transform(Vector3D vector);
public Point4D Transform(Point4D point);
public void Transform(Point3D[ ] points);
public void Transform(Vector3D[ ] vectors);
public void Transform(Point4D[ ] points);

}

Note that the Transform( ) methods that take Point3D/Vector3D will raise an exception if the transform is not affine.

Transform3DCollection

Transform3D collection object 804 will exactly mimic TransformCollection in visual 2D, with the Add methods modified in the same way that the Create methods above are.

public sealed class System.Windows.Media3D.Transform3DCollection :
Transform3D, IList
{

// follow the model of TransformCollection

}

AffineTransform3D

Affine Transform3D object 806 is simply a base class that all concrete affine 3D transforms derive from (translate, skew, rotate, scale), and it exposes read access to a Matrix3D.

public abstract class System.Windows.Media3D.AffineTransform3D :
Transform3D
{

internal AffineTransform3D( ); // non-extensible
public virtual Matrix3D Value { get; }

}

Translate Transform3D Object 808

public sealed class System.Windows.Media3D.TranslateTransform3D :
AffineTransform3D
{

public TranslateTransform3D( );
public TranslateTransform3D(Vector3D offset);
public TranslateTransform3D(Vector3D offset,
Vector3DAnimationCollection offsetAnimations);
public new TranslateTransform3D Copy( );
[Animations(“OffsetAnimations”)]
public Vector3D Offset { get; set; }
public Vector3DAnimationCollection OffsetAnimations
{ get; set; }
public override Matrix3D value { get; }

}

ScaleTransform3D Object 812

public sealed class System.Windows.Media3D.ScaleTransform3D :
AffineTransform3D
{

public ScaleTransform3D( );
public ScaleTransform3D(Vector3D scaleVector);
public ScaleTransform3D(Vector3D scaleVector,
Point3D scaleCenter);
public ScaleTransform3D(Vector3D scaleVector,
Vector3DAnimationCollection scaleVectorAnimations,
Point3D scaleCenter,
Point3DAnimationCollection scaleCenterAnimations);
public new ScaleTransform3D Copy( );
[Animations(“scaleVectorAnimations”)]
public Vector3D scaleVector { get; set; }
public Vector3DAnimationcollection scaleVectorAnimations
{ get; set; }
[Animations(“ScaleCenterAnimations”)]
public Point3D ScaleCenter { get; set; }
public Point3DAnimationCollection ScaleCenterAnimations
{ get; set; }
public override Matrix3D Value { get; }

}

RotateTransform3D

RotateTransform3D object 812 is more than just a simple mapping from the 2D rotate due to the introduction of the concept of an axis to rotate around (and thus the use of quaternions).

public sealed class RotateTransform3D : AffineTransform3D
{

public RotateTransform3D( );
public RotateTransform3D(Vector3D axis, double angle);
public RotateTransform3D(Vector3D axis, double angle,
Point3D center);
// Quaternions supplied to RotateTransform3D methods
must be normalized,
// otherwise an exception will be raised.
public RotateTransform3D(Quaternion quaternion);
public RotateTransform3D(Quaternion quaternion,
Point3D center);
public RotateTransform3D (

Quaternion quaternion,
QuaternionAnimationCollection quaternionAnimations,
Point3D center,
Point3DAnimationCollection centerAnimations);

public new RotateTransform3D Copy( );
// Angle/Axis are just a different view on the
QuaternionRotation parameter. If
// Angle/Axis changes, QuaternionRotation will change
accordingly, and vice-versa.
public double Angle { get; set; }
public Vector3D Axis { get; set; }
[Animations(“QuaternionRotationAnimations”)]
public Quaternion QuaternionRotation { get; set; }
public QuaternionAnimationCollection
QuaternionRotationAnimations { get; set; }
[Animations(“CenterAnimations”)]
public Point3D Center { get; set; }
public Point3DAnimationCollection CenterAnimations
{ get; set; }
public override Matrix3D value { get; }

}

Note that only the Quaterion property here is animatable. In general, animations of axis/angles don't tend to work out well. Better to animate the quaternion, and we can extract axes and angles from the base value of the quaternion. If you do want to simply animate an angle against a fixed axis, the easy way to specify this is to build two quaternions representing those positions, and animate between them.

MatrixTransform3D

MatrixTransform3D object 814 builds a Transform3D directly from a Matrix3D.

public sealed class System.Windows.Media3D.MatrixTransform3D :
Transform3D
{

public MatrixTransform3D( );
public MatrixTransform3D(Matrix3D matrix);
public new MatrixTransform3D Copy( );
public Matrix3D Value { get; set; }

}

Transform3D TypeConverter

When a Transform3D type property is specified in markup, the property system uses the Transform type converter to convert the string representation to the appropriate Transform derived object. There is no way to describe animated properties using this syntax, but the complex property syntax can be used for animation descriptions.

Syntax

The syntax is modeled off of the 2D Transform. <> represent optional parameters.
matrix(m00 m01 m02 m03 m11 . . . m33)
translate(tx ty tz)
scale(sx <sy> <sz> <cx> <cy> <cz>)
   If <sy> or <sz> is not specified it is assumed to be a uniform scale.
   If <cx> <cy> <cz> are specified, then they all need to be specified, and <sx> <sy> do as well. They are used for the scaling center. If they're not, center is assumed to be 0,0,0.
rotate(ax ay az angle <cx> <cy> <cz>)
   ax,ay,az specifies axis of rotation
   angle is the angle through that axis
   If cx, cy, cz is not specified its assumed to be 0,0,0.
skew(angleX angleY angleZ <cx> <cy> <cz>)
   If cx, cy, cz is not specified its assumed to be 0,0,0.

Grammar

transform-list:

wsp* transforms? wsp*

transforms:

transform
| transform comma-wsp+ transforms

transform:

matrix
| translate
| scale
| rotate
| skewX
| skewY

matrix:

“matrix” wsp* “(“ wsp*

number comma-wsp
number comma-wsp
... 13 more times ...
number wsp* ”)”

translate:

“translate” wsp* “(“ wsp* number
( comma-wsp number comma-wsp number )? wsp* ”)”

scale:

“scale” wsp* “(“ wsp* number
(comma-wsp number comma-wsp number

(comma-wsp number comma-wsp
number comma-wsp number)?

)? wsp* ”)”

rotate:

“rotate” wsp* “(“ wsp* number wsp*
number wsp* number wsp* number

( comma-wsp number comma-wsp number
comma-wsp number )? wsp* ”)”

skew:

“rotate” wsp* “(“ wsp* number wsp* number wsp* number

( comma-wsp number comma-wsp number
comma-wsp number )? wsp* ”)”

Visual3D

Visual3D object 22 in FIG. 1 derives from Visual2D, and in so doing gets all of its properties, including:
Opacity
2D Geometric Clip
2D Blend Mode
Hit Testing API
2D Bounds query
Participation in Visual tree

Note that all of the opacity, clip, blend mode, and bounds all apply to the 2D projection of the 3D scene.

public class System.Windows.Media3D.Visual3D : Visual
{

public Visual3D( );
public Visual3D(UIContext Context);
// Modeling-oriented semantics. Default value is an empty collection.
public Model3DCollection Models { get; set; }
// Ambient properties
// Camera - there's no default, it's an error not to provide one.
public Camera Camera { get; set; }
// Viewport establishes where the projection maps to in 2D.
Default is 0,0,1,1
[Animation(“ViewPortAnimations”)]
public Rect viewport { get; set; }
public RectAnimationCollection ViewPortAnimations { get; set; }
public Fog Fog { get; set; }

}

The ViewPort box establishes where the projection determined by the Camera/Models combination maps to in 2D local coordinate space.
Drawing3DContext

The Drawing3DContext very much parallels the 2D DrawingContext, and is accessible from the Model3DCollection of a Visual3D via RenderOpen/RenderAppend. It feels like an immediate-mode rendering context, even though it's retaining instructions internally.

public class System.Windows.Media3D.Drawing3DContext : IDisposable
{

internal Drawing3DContext( ); // can't be publicly constructed
// Rendering
public void DrawMesh(Mesh3D mesh, Material material, object
hitTestToken);
// These are for drawing imported primitives like .x files
public void DrawImportedPrimitive(ImportedPrimitive3DSource
primitiveSource,

object hitTestToken);

public void DrawImportedPrimitive(ImportedPrimtive3DSource
primitiveSource,

Material overridingMaterial,
object hitTestToken);

public void Drawvisual(Visual visual, Point3D centerPosition,

object hitTestToken);

public void DrawModel(Model3D model);
public void AddLight(Light light);
// Stack manipulation
public void PushTransform(Transform3D transform);
public void Pop( );
public void Close( ); // Also invoked by Dispose( );

}

For the specific details on the semantics of these Drawing3DContext operations, refer to the Modeling API section, for which the Drawing3DContext really is just a convenience for. For example, DrawImportedPrimitive (ImportedPrimitive3DSource primitiveSource, objectHitTestToken) simply creates an ImportedPrimitive3D, and adds it into the currently accumulating Model3D (which in turn is manipulated by Push/Pop methods on the context).

DrawModel( ) is another crossover point between the “context” world and the “modeling” world, allowing a Model3D to be “drawn” into a context.

There is no explicit “readback” from the Drawing3DContext. That's because it simply has the Model3DGroup backing it, and one can always enumerate that collection.

Modeling API

This is the public and protected API for these classes, not showing inherited members.

Model3D

Model3D object 10 in FIG. 1 is the abstract model object that everything builds from.

public abstract class Model 3D : Changeable
{

public Transform3D Transform { get; set; } // defaults to
Identity
public ShadingMode ShadingMode { get; set; }
public object HitTestToken { get; set; }
public Rect3D Bounds3D { get; } // Bounds for this model
// singleton “empty” model.
public static Model3D EmptyModel3D { get; }

}

Model3DGroup

Model3DGroup object 18 in FIG. 1 is where one constructs a combination of models, and treats them as a unit, optionally transforming or applying other attributes to them.

public sealed class Model3DGroup : Model 3D
{

public Model3DGroup( );
// Drawing3DContext semantics
public Drawing3DContext RenderOpen( );
public Drawing3DContext RenderAppend( ):
// Model3DCollection is a standard IList of Model3Ds.
public Model3DCollection Children { get; set; }

}

Note that Model3DGroup also has RenderOpen/Append, which returns a Drawing3DContext. Use of this context modifies the Model3DCollection itself. The difference between RenderOpen( ) and RenderAppend( ) is that RenderOpen( ) clears out the collection first.

Note also that only one Drawing3DContext may be open at a time on a Model3DGroup, and when it's opened, applications may not directly access (for read or write) the contents of that Model3DGroup.

Light Hierarchy

Light objects are Model3D objects. They include Ambient, Positional, Directional and Spot lights. They're very much modeled on the Direct3D lighting set, but have the additional property of being part of a modeling hierarchy, and are thus subject to coordinate space transformations.

Ambient, diffuse, and specular colors are provided on all lights.

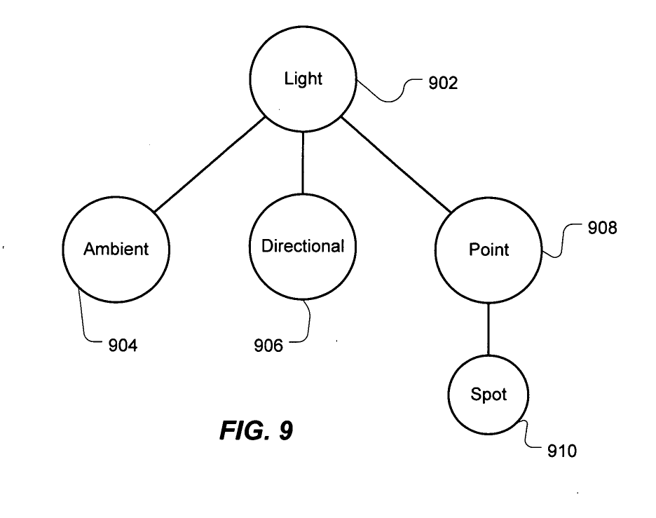

The light hierarchy looks like this and is also shown in FIG. 9:

Model3D
Light (abstract)
   AmbientLight (concrete)
   DirectionalLight (concrete)
   PointLight (concrete)
      SpotLight (concrete)

The base light object 902 class is an abstract one that simply has

public abstract class Light : Model3D
{

internal Light( ); // only allow public construction -
no 3^{rd} party lights
[Animation(“AmbientColorAnimations”)]
public Color AmbientColor { get; set; }
public ColorAnimationCollection AmbientColorAnimations
{ get; set; }
[Animation(“DiffuseColorAnimations”)]
public Color DiffuseColor { get; set; }
public ColorAnimationCollection DiffuseColorAnimations
{ get; set; }
[Animation(“SpecularColorAnimations”)]
public Color SpecularColor { get; set; }
public ColorAnimationCollection SpecularColorAnimations
{ get; set; }

}

AmbientLight

Ambient light object 904 lights models uniformly, regardless of their shape.

public sealed class AmbientLight : Light
{

public AmbientLight(Color ambientColor);

}

DirectionalLight

Directional lights from a directional light object 906 have no position in space and project their light along a particular direction, specified by the vector that defines it.

public sealed class DirectionalLight : Light
{

public DirectionalLight(Color diffuseColor,
Vector3D direction); // common usage
[Animation(“DirectionAnimations”)]
public Vector3D Direction { get; set; }
public Vector3DAnimationCollection DirectionAnimations
{ get; set; }

}

The direction needn't be normalized, but it also must have non-zero magnitude.

PointLight

Positional lights from a point light objects 908 have a position in space and project their light in all directions. The falloff of the light is controlled by attenuation and range properties.

[ strong name inheritance demand so 3^{rd} parties can't
derive... we can't seal, since

SpotLight derives from this ...]

public class PointLight : Light
{

public PointLight(Color diffuseColor, Point3D position);
// common usage
[Animation(“PositionAnimations”)]
public Point3D Position { get; set; }
public Point3DAnimationCollection PositionAnimations
{ get; set; }
// Range of the light. beyond which it has no effect.
This is specified
// in local coordinates.
[Animation(“RangeAnimations”)]
public double Range { get; set; }
public DoubleAnimationCollection RangeAnimations { get; set; }
// constant, linear, and quadratic attenuation factors
defines how the light
// attenuates between its position and the value of Range.
[Animation(“ConstantAttenuationAnimations”)]
public double ConstantAttenuation { get; set; }
public DoubleAnimationCollection ConstantAttenuationAnimations
{ get; set; }
[Animation(“LinearAttenuationAnimations”)]
public double LinearAttenuation { get; set; }
public DoubleAnimationCollection LinearAttenuationAnimations
{ get; set; }
[Animation(“QuadraticAttenuationAnimations”)]
public double QuadraticAttenuation { get; set; }
public DoubleAnimationCollection QuadraticAttenuationAnimations
{ get; set; }

}

SpotLight

The SpotLight derives from PointLight as it has a position, range, and attenuation, but also adds in a direction and parameters to control the “cone” of the light. In order to control the “cone”, outerConeAngle (beyond which nothing is illuminated), and innerConeAngle (within which everything is fully illuminated) must be specified. Lighting between the outside of the inner cone and the outer cone falls off linearly. (A possible source of confusion here is that there are two falloffs going on here—one is “angular” between the edge of the inner cone and the outer cone; the other is in distance, relative to the position of the light, and is affected by attenuation and range.)

public sealed class SpotLight : PointLight
{

public SpotLight(Color color,

Point3D position,
Vector3D direction,
double outerConeAngle,
double innerConeAngle);

[Animation(“DirectionAnimations”)]
public Vector3D Direction { get; set; }
public Vector3DAnimationCollection DirectionAnimations
{ get; set; }
[Animation(“OuterConeAngleAnimations”)]
public double OuterConeAngle { get; set; }
public DoubleAnimationCollection OuterConeAngleAnimations
{ get; set; }
[Animation(“InnerConeAngleAnimations”)]
public double innerConeAngle { get; set; }
public DoubleAnimationCollection InnerConeAngleAnimations
{ get; set; }

}

Note that angles are specified in degrees.

Primitive3D

Primitive3D objects 12 in FIG. 1 are leaf nodes that result in rendering in the tree. Concrete classes bring in explicitly specified meshes, as well as imported primitives (.x files).

public abstract class Primitive3D : Model3D
{

internal Primitive3D(object hitTestToken);

}

MeshPrimitive3D

MeshPrimitive3D is for modeling with a mesh and a material.

public sealed class MeshPrimitive3D : Primitive3D
{

public MeshPrimitive3D(Mesh3D mesh, Material material,
object hitTestToken);
public Mesh3D Mesh { get; set; }
public Material Material { get; set; }

}

Note that MeshPrimitive3D is a leaf geometry, and that it contains but is not itself, a Mesh. This means that a Mesh can be shared amongst multiple MeshPrimitive3D's, with different materials, subject to different hit testing, without replicating the mesh data.

ImportedPrimitive3D

ImportedPrimitive3D represents an externally acquired primitive (potentially with material and animation) brought in and converted into the appropriate internal form. It's treated by Avalon as a rigid model. The canonical example of this is an .X File, and there is a subclass of ImportedPrimitive3DSource that explicitly imports XFiles.

public sealed class ImportedPrimitive3D : Primitive3D
{

public ImportedPrimitive3D(ImportedPrimitive3DSource primitive,

object hitTestToken);

public ImportedPrimitive3DSource PrimitiveSource { get; set; }
// Allow overriding the imported material(s) if there was any.
If not specified,
// this is null, and the built in material is used.
public Material OverridingMaterial { get; set; }

}

TypeConverter for ImportedPrimitive3D

Since .x files are included in scenes, a simple TypeConverter format for expressing this should look something like:

<ImportedPrimitive3D xfile=“myFile.x” />

VisualModel3D

The VisualModel3D takes any Visual (2D, by definition), and places it in the scene. When rendered, it will be screen aligned, and its size won't be affected, but it will be at a particular z-plane from the camera. The Visual will remain interactive.

public sealed class VisualModel3D : Model3D
{

public VisualModel3D(Visual visual, Point3 centerPoint,
object hitTestToken);
public Visual Visual { get; set; }
public Point3D CenterPoint { get; set; }

}

Rendering a VisualModel3D first transforms the CenterPoint into world coordinates. It then renders the Visual into the pixel buffer in a screen aligned manner with the z of the transformed CenterPoint being where the center of the visual is placed. Under camera motion, the VisualModel3D will always occupy the same amount of screen real estate, and always be forward facing, and not be affected by lights, etc. The fixed point during this camera motion of the visual relative to the rest of the scene will be the center of the visual, since placement happens based on that point.

The Visual provided is fully interactive, and is effectively “parented” to the Visual3D enclosing it (note that this means that a given Visual can only be used once in any VisualModel3D, just like a Visual can only have a single parent.

Mesh3D

The Mesh3D primitive is a straightforward triangle primitive (allowing both indexed and non-indexed specification) that can be constructed programmatically. Note that it supports position, normal, color, and texture information, with the last three being optional. The mesh also allows selection of whether it is to be displayed as triangles, lines, or points. It also supports the three topologies for interpreting indices: triangle list, triangle strip, and triangle fan.

For vertex formats and other primitive construction that are not supported directly by Mesh3D, an .x file can be constructed and imported.

public sealed class System.Windows.Media3D.Mesh3D : Changeable
{

public Mesh3D( );
// Vertex data. Normals, Colors, and TextureCoordinates
are all optional.
public Point3DCollection Positions { get; set; }
public Vector3DCollection Normals { get; set; }
// assumed to be normalized
public ColorCollection Colors { get; set; }
public ColorCollection SpecularColors { get; set; }
public PointCollection TextureCoordinates { get; set; }
// Topology data. If null, treat as non-indexed primitive
public IntegerCollection TriangleIndices { get; set; }
// Primitive type - default = TriangleList
public MeshPrimitiveType MeshPrimitiveType { get; set; }

}

MeshPrimitiveType is defined as:

public enum System.Windows.Media3D.MeshPrimitiveType
{

TriangleList,
TriangleStrip,
TriangleFan,
LineList,
LineStrip,
PointList

}

Interpretation of the Mesh Data

The per-vertex data in Mesh3D is divided up into Positions, Normals, Colors, and TextureCoordinates. Of these, only Positions is required. If any of the other are provided, they must have the exact same length as the Positions collection, otherwise an exception will be raised.

The Normals, if provided, are assumed to be normalized. When normals are desired, they must be supplied.

The TriangleIndices collection has members that index into the vertex data to determine per-vertex information for the triangles that compose the mesh. This collection is interpreted based upon the setting of MeshPrimitiveType. These interpretations are the exact same as those in Direct3D. For TriangleList, every three elements in the TriangleIndices collection defines a new triangle. For TriangleFan, indices 0,1,2 determine the first triangle, then each subsequent index, i, determines a new triangle given by vertices 0,i,i−1. For TriangleStrip, indices 0,1,2 determine the first triangle, and each subsequent index i determines a new triangle given by vertices i−2, i−1, and i. LineList, LineStrip, and PointList have similar interpretations, but the rendering is in terms of lines and points, rather than triangles.

If TriangleIndices is null, then the Mesh is implemented as a non-indexed primitive, which is equivalent to TriangleIndices holding values 0,1, . . . ,n−2,n−1 for a Positions collection of length n.

Construction of Mesh and Avoiding Data Replication

Upon construction of the Mesh, the implementation creates the optimal D3D structure that represents this mesh. At this point, the actual Collection data structures can be thrown away by the Mesh implementation to avoid duplication of data. Subsequent readback of the mesh if accessed in through some other mechanism (traversing the Visual3Ds model hierarchy for instance) will likely reconstruct data from the D3D information that is being held onto, rather than retaining the original data.¹

Changeability of Mesh

The mesh derives from Changeable, and thus can be modified. The implementation will need to trap sets to the vertex and index data, and propagate those changes to the D3D data structures.

TypeConverters for Mesh

Like all the other types, the XAML complex property syntax can be used to specify the collections that define Mesh3D. However, TypeConverters are provided to make the specification more succinct.

Each collection defined in mesh can take a single string of numbers to be parsed and used to create the collection. For instance, a Mesh representing an indexed triangle strip with only positions and colors could be specified as:

<Mesh3D

meshPrimitiveType=“TriangleStrip”
positions=“1,2,3, 4,5,6, 7,8,9, 10,11,12, 13,14,15, 16,17,18”
colors=“red blue green cyan magenta yellow”
triangleIndices=“1,3,4,1,2,3,4,5,6,1,2,4,2”
/>

Of course, any of these could be represented much more verbosely in the complex property syntax.
Material

The methods that construct Primitive3D's take a Material to define their appearance. Material is an abstract base class with three concrete subclasses: BrushMaterial, VisualMaterial, and AdvancedMaterial. BrushMaterial and VisualMaterial are both subclasses of another abstract class called BasicMaterial. Thus:

Material
BasicMaterial
   BrushMaterial
   VisualMaterial
AdvancedMaterial
The BrushMaterial simply takes a single Brush and can be used for a wide range of effects, including achieving transparency (either per-pixel or scalar), having a texture transform (even an animate one), using video textures, implicit auto-generated mipmaps, etc. Specifically, for texturing solid colors, images, gradients, or even another Visual, one would just use a SolidColorBrush, ImageBrush, GradientBrush, or VisualBrush to create their BrushMaterial.
The VisualMaterial is specifically designed to construct a material out of a Visual. This material will be interactive in the sense that input will pass into the Visual from the 3D world that it's embedded in. One might wonder about the difference between this and a BrushMaterial with a VisualBrush. The difference is that the BrushMaterial is non-interactive.

The AdvancedMaterial class, while it's considerably more complex than simply using a BrushMaterial or VisualMaterial, provides for even more flexibility. However, the non-3D-Einstein needn't know about AdvancedMaterial and can simply use BrushMaterial/VisualMaterial to achieve most of what they'd like to achieve.

public abstract class Material : Changeable
{

internal Material( ); // don't allow external subclassing
public new Material Copy( ); // shadows Changeable.Copy( )
public static Material Empty { get; } // singleton material

}
public abstract class BasicMaterial : Material
{

internal BasicMaterial( ); // don't allow external subclassing
public new BasicMaterial Copy( ); // shadows Changeable.Copy( )
Matrix TextureTransform { get; set; } // defaults to identity

}

Materials gain tremendous flexibility and “economy of concept” by being based on a Brush. Specifically:
There needn't be a separate Texture hierarchy reflecting things like video textures, gradient textures, etc., since those are all specifiable as Brushes.
Brushes already encapsulate both alpha-mask and scalar opacity values, so those both become available to texturing.
Brushes already have a 2D Transform associated with them which, in the case of texturing, will be interpreted as a texture transform for transforming uv coordinates in the mesh to map into the texture.
Brushes are the right place to hang, in the future, stock procedural shaders such as a wood grain shader. This would then be usable in 2D as a fill or pen, and in 3D as a texture. No specific API support need be given in the 3D space for procedural shaders.

Note: the TextureTransform property is distinct from any transform that might exist inside the definition of a BrushMaterial or VisualMaterial. It specifies the transformation from the Material in question to texture coordinate space (whose extents are [0,0] to [1,1]). A transform inside the Material combines with the TextureTransform to describe how the 1×1 (in texture coordinate) Material is mapped over a Mesh.

Shaders

A set of “stock” shaders, many of which are parameterized, are accessible in the API as follows:
1) For shaders that make sense in the 2D world, they'll be exposed as concrete subclasses of Brush, with their parameterization expressed either through the constructors on the class, or as properties on the class. They can then be applied to 2D objects.
2) For shaders that only make sense in 3D, they'll be exposed as concrete subclasses of Material or BasicMaterial, where they can also be parameterized through their constructor.

This exposure will then allow the shaders to be applied to 3D (and 2D where appropriate) meshes.

BrushMaterial

As described above, BrushMaterial simply encapsulates a Brush. A BrushMaterial applied to a Primitive3D is treated as a texture. Textures will be mapped directly—that is, the 2D u,v coordinates on the primitive being mapped will index directly into the correspond x,y coordinates on the Texture, modified by the texture transform. Note that, like all 2D in Avalon, the texture's coordinate system runs from (0,0) at the top left with positive y pointing down.

A VisualBrush used for the Brush will not accept input, but it will update according to any animations on it, or any structural changes that happen to it. To use a Visual as a Material and still receive input, use the VisualMaterial, described below.

public sealed class BrushMaterial : BasicMaterial
{

public BrushMaterial(Brush brush);
public new BrushMaterial Copy( ); // shadows Material.Copy( )
public Brush Brush { get; set; }
// Additional texturing specific knobs.

}

VisualMaterial

As described above, VisualMaterial encapsulates an interactive Visual. This differs from BrushMaterial used with a Visual in that the Visual remains live in its textured form. Note that the Visual is then, in effect, parented in some fashion to the root Visual3D. It is illegal to use a single UIElement in more than one Material, or to use a VisualMaterial in more than one place.

public sealed class VisualMaterial : BasicMaterial
{

public VisualMaterial(Visual visual);
public new VisualMaterial Copy( ); // shadows Changeable.Copy( )
public Visual Visual { get; set; }
--(need to add viewport/viewbox stuff for positioning...)
// Additional texturing specific knobs.

}

AdvancedMaterial

BrushMaterials/VisualMaterials and BumpMaps are used to define AdvancedMaterials.

public class AdvancedMaterial : Material
{

public AdvancedMaterial( );
// TODO: Add common constructors.
public new AdvancedMaterial Copy( );
// shadows Changeable.Copy( )
public BasicMaterial DiffuseTexture { get; set; }
public BasicMaterial SpecularTexture { get; set; }
public BasicMaterial AmbientTexture { get; set; }
public BasicMaterial EmissiveTexture { get; set; }
[ Animations(“SpecularPowerAnimations”) ]
public double SpecularPower { get; set; }
public DoubleAnimationCollection SpecularPowerAnimations
{ get; set; }
public BumpMap DiffuseBumpMap { get; set; }
public BumpMap ReflectionBumpMap { get; set; }
public BumpMap RefractionBumpMap { get; set; }
public BrushMaterial ReflectionEnvironmentMap { get; set; }
public BrushMaterial RefractionEnvironmentMap { get; set; }

}

Note that the EnvironmentMaps are textures that are expected to be in a particular format to enable cube-mapping. Specifically, the six faces of the cube map will need to be represented in well known sections of the Brush associated with the Texture (likely something like a 3×2 grid on the Brush).

The Ambient, Diffuse, and Specular properties take a BasicMaterial, and not a general Material since they're not specified as AdvancedMaterials themselves. Note also that the environment maps are BrushMaterials.

BumpMap Definition

Bump maps are grids that, like textures, get mapped onto 3D primitives via texture coordinates on the primitives. However, the interpolated data is interpreted as perturbations to the normals of the surface, resulting in a “bumpy” appearance of the primitive. To achieve this, bump maps carry information such as normal perturbation, and potentially other information. They do not carry color or transparency information. Because of this, it's inappropriate to use a Brush as a bump map.

Therefore, we introduce a new BumpMap class, which is going to be an ImageSource of a particular pixel format.

public sealed class BumpMap : ImageSource
{

// Fill this in when we figure out issues below.

}

TypeConverter for Material

Material offers up a simple TypeConverter that allows the string specification of a Brush to automatically be promoted into a BrushMaterial:

Material:

... delegate to Brush type converter ...

This allows specifications like:

<MeshPrimitive3D ... material=“yellow” />
<MeshPrimitive3D ... material=“LinearGradient blue green” />
<MeshPrimitive3D ... material=“HorizontalGradient orange purple” />
<MeshPrimitive3D ... material=“*Resource(myImageResource)” />

“Ambient” Parameters

This section discusses “ambient” parameters of the model . . . those that aren't embeddable at arbitrary levels in the geometric hierarchy.

Fog

Fog can be added to the scene by setting the Fog property on the Visual3D. The Fog available is “pixel fog”. Fog is represented as an abstract class, and hierarchy as shown below:

public abstract class Fog : Changeable
{

// only constructable internally
internal Fog(Color color);
public new Fog Copy( ); // hides Changeable.Copy( )
[Animation(“ColorAnimations”)]
public Color Color { get; set; }
public ColorAnimationCollection ColorAnimations { get; set; }
// singleton representation of “no fog”
public static Fog Empty { get; }

}
public sealed class LinearFog : Fog
{

public LinearFog(Color color, double fogStart, double fogEnd);
[Animation(“FogStartAnimations”)]
public double FogStart { get; set; }
public DoubleAnimationCollection FogStartAnimations
{ get; set; }
[Animation(“FogEndAnimations”)]
public double FogEnd { get; set; }
public DoubleAnimationCollection FogEndAnimations { get; set; }

}
public sealed class ExponentialFog : Fog
{

public ExponentialFog(Color color, double fogDensity,
bool squaredExponent);
[Animation(“FogDensityAnimations”)]
public double FogDensity { get; set; }
public DoubleAnimationCollection FogDensityAnimations
{ get; set; }
public bool SquaredExponent { get; set; }

}

fogDensity ranges from 0-1, and is a normalized representation of the density of the fog.
fogStart and fogEnd are z-depths specified in device space [0,1] and represent where the fog begins and ends.

Camera

The Camera object 32 in FIG. 1 is the mechanism by which a 3D model is projected onto a 2D visual. The Camera itself is an abstract type, two subclasses—ProjectionCamera and MatrixCamera. ProjectionCamera is itself an abstract class with two concrete subclasses—PerspectiveCamera and OrthogonalCamera. PerspectiveCamera takes well-understood parameters such as Position, LookAtPoint, and FieldOfView to construct the Camera. OrthogonalCamera is similar to PerspectiveCamera except it takes a Width instead of a FieldOfView. MatrixCamera takes a Matrix3D used to define the World-To-Device transformation.

public abstract class Camera : Changeable
{

// Only allow to be built internally.
internal Camera( );
public new Camera Copy( ); // hides Changeable.Copy( )

}

In a Visual3D, a Camera is used to provide a view onto a Model3D, and the resultant projection is mapped into the 2D ViewPort established on the Visual3D.

Also note that the 2D bounding box of the Visual3D will simply be the projected 3D box of the 3D model, wrapped with its convex, axis-aligned hull, clipped to the clip established on the visual.

ProjectionCamera

The ProjectionCamera object 39 in FIG. 1 is the abstract parent from which both PerspectiveCamera and OrthogranalCamera derive. It encapsulates properties such as position, lookat direction and up direction that are common to both types of ProjectionCamera that the MIL (media integration layer) supports.

public abstract class ProjectionCamera : Camera
{

// Common constructors
public ProjectionCamera( );
// Camera data
[Animations(“NearPlaneDistanceAnimations”)]
public double NearPlaneDistance { get; set; }
// default = 0
public DoubleAnimationCollection NearPlaneDistanceAnimations
{ get; set; }
[Animations(“FarPlaneDistanceAnimations”)]
public double FarPlaneDistance { get; set; }
// default = infinity
public DoubleAnimationCollection FarPlaneDistanceAnimations
{ get; set; }
[Animations(“PositionAnimations”)]
public Point3D Position { get; set; }
public Point3DAnimationCollection PositionAnimations
{ get; set; }
[Animations(“LookDirectionAnimations”)]
public Point3D LookDirection { get; set; }
public Point3DAnimationCollection LookDirectionAnimations
{ get; set; }
[Animations(“UpAnimations”)]
public Vector3D up { get; set; }
public Vector3DAnimationCollection UpAnimations { get; set; }

}

PerspectiveCamera

The PerspectiveCamera object 36 in FIG. 1 is the means by which a perspective projection camera is constructed from well-understand parameters such as Position, LookAtPoint, and FieldOfView. The following illustration provides a good indication of the relevant aspects of a PerspectiveCamera.

[image]

public class PerspectiveCamera : ProjectionCamera
{

// Common constructors
public PerspectiveCamera( );
public PerspectiveCamera(Point3D position,

Point3D lookDirection,
Vector3D Up,
double fieldOfView);

public new ProjectionCamera Copy( ); // hides Changeable.Copy( )
[Animations(“FieldOfViewAnimations”)]
public double FieldOfView { get; set; }
public DoubleAnimationCollection FieldOfViewAnimations
{ get; set; }

}

Some notes:
The PerspectiveCamera inherits the position, lookat direction and up vector properties from ProjectionCamera
The FieldOfView represents the horizontal field of view, and is specified in degrees (like all other MIL angles).
The Near and Far PlaneDistances represent 3D world-coordinate distances from the camera's Position along the vector defined by the LookDirection point. The NearPlaneDistance defaults to 0 and the FarPlaneDistance defaults to infinity.
Upon actual projection, if the Near/FarPlaneDistances are still 0/infinity respectively, then the model is examined and its bounding volume is projected according to the camera projection. The resulting bounding volume is then examined so that the near plane distance is set to the bounding volume's plane perpendicular to the LookDirection nearest the camera position. Same for the far plane, but using the farthest plane. This results in optimal use of z-buffer resolution while still displaying the entire model.

Note that the “projection plane” defined by the parameters of the PerspectiveCamera is then mapped into the ViewPort rectangle on the Visual3D, and that represents the final transition from 3-space to 2-space.

OrthogonalCamera

The OrthogonalCamera object 37 in FIG. 1 specifies an orthogonal projection from world to device space. Like a PerspectiveCamera, the OrthogonalCamera, or orthographic camera, specifies a position, lookat direction and up direction. Unlike a PerspectiveCamera, however, the OrthogonalCamera describes a projection that does not include perspective foreshortening. Physically, the OrthogonalCamera describes a viewing box whose sides are parallel (where the PerspectiveCamera describes a viewing frustrum whose sides ultimately meet in a point at the camera).

public class OrthoganalCamera : ProjectionCamera
{

// Common constructors
public OrthogonalCamera( );
public OrthogonalCamera(Point3D position,

Point3D lookDirection,
Vector3D Up,
double width);

public new ProjectionCamera Copy( ); // hides Changeable.Copy( )
[Animations(“WidthAnimations”)]
public double Width { get; set; }
public DoubleAnimationCollection WidthAnimations { get; set; }

}

Some notes:
The OrthogonalCamera inherits the position, lookat direction and up vector properties from ProjectionCamera
The Width represents the width of the OrthoganalCamera's viewing box, and is specified in world units.
The Near and Far PlaneDistances behave the same way they do for the PerspectiveCamera.

MatrixCamera

The MatrixCamera object 38 in FIG. 1 is a subclass of Camera and provides for directly specifying a Matrix as the projection transformation. This is useful for apps that have their own projection matrix calculation mechanisms. It definitely represents an advanced use of the system.

public class MatrixCamera : Camera
{

// Common constructors
public MatrixCamera( );
public MatrixCamera(Matrix3D ViewMatrix, Matrix3D
ProjectionMatrix);
public new MatrixCamera Copy( ); // hides Changeable.Copy( )
// Camera data
public Matrix3D ViewMatrix { get; set; }
// default = identity
public Matrix3D ProjectionMatrix {get; set; }
// default = identity

}

Some notes:
The ViewMatrix represents the position, lookat direction and up vector for the MatrixCamera. This may differ from the top-level transform of the Model3D hierarchy because of billboarding. The ProjectionMatrix transforms the scene from camera space to device space.
The MinimumZ and MaximumZ properties have been removed because these values are implied by the MatrixCamera's projection matrix. The projection matrix transforms the coordinate system from camera space to a normalized cube where X and Y range from [−1,1] and z ranges from [0,1]. The minimum and maximum z coordinates in camera space are defined by how the projection matrix transforms the z coordinate.

Note that the resultant projection is mapped into the ViewPort rectangle on the Visual3D, and that represents the final transition from 3-space to 2-space.

XAML Markup Examples

The following are more complete markups showing specification of an entire Model3D hierarchy in XAML. Note that some of the syntax may change with general

Simple x-File Importation and Composition

This example simply creates a Model with two imported .x files and a rotation transform (about the z-axis by 45 degrees) one on of them, and a single white point light sitting up above at 0,1,0.

<Model3DGroup>

<!-- Model children go as children here --/>
<PointLight position=“0,1,0” diffuseColor=“white” />
<ImportedPrimitive3D xfile=“myFile.x” />
<Model3DGroup transform=“rotate(0, 0, 1, 45), scale(2)” >

<ImportedPrimitive3D xfile=“mySecondeFile.x” />

</Model3DGroup>

</Model3DGroup>

Now, this markup will then be in a file, a stream, a resource—whatever. A client program will invoke loading of that XAML, and that will in turn construct a complete Model3DGroup, to be used by the application as it sees fit.

Explicit Mesh Declaration

This example provides an explicitly declared MeshPrimitive3D, through the use of the complex-property XAML syntax. The mesh will be textured with a LinearGradient from yellow to red.

There is also a light in the scene.

<Model3DGroup>

<!-- Model children go as children here --/>
<PointLight position=“0,1,0” diffuseColor=“white” />
<MeshPrimitive3D material=“LinearGradient yellow red”>

<MeshPrimitive3D.Mesh>

<Mesh3D

meshPrimitiveType=“TriangleStrip”
positions=“1,2,3, 4,5,6, 7,8,9, 10,11,12,
13,14,15, 16,17,18”
normals=“... sensible normal vectors ...”
textureCoordinates=“.5,.5, 1,1, 0,0,
.25,.25, .3,.4, .7,.8”
triangleIndices=“1,3,4,1,2,3,4,5,6,1,2,4,2” />

</MeshPrimitive3D.Mesh>

</MeshPrimitive3D>

</Model3DGroup>

Animations on .x Files

This example takes the first .x file and adds in a XAML-specified animation. This particular one adds a uniform scale that scales the x file from 1× to 2.5× over 5 seconds, reverses, and repeats indefinitely. It also uses acceleration/deceleration to slow-in/slow-out of its scale.

<Model3DGroup>

<!-- Model children go as children here --/>
<PointLight position=“0,1,0” diffuseColor=“white” />
<ImportedPrimitive3D xfile=“myFile.x”>

<ImportedPrimitive3D.Transform>

<ScaleTransform3D>

<ScaleTransform3D.ScaleVector>

<VectorAnimation

from=“1,1,1”
to=“2.5,2.5,2.5”
begin=“immediately”
duration=“5”
autoReverse=“true”
repeatDuration=“indefinite”
acceleration=“0.1”
decelerateon=“0.1” />

</ScaleTransform3D.ScaleVector>

<ScaleTransform3D>

</ImportedPrimitive3D.Transform>

</ImportedPrimitive3D>

</Model3DGroup>

VisualMaterial Specification

This example imports a .x file and applies a live UI as its material.

<Model3DGroup>

<!-- Model children go as children here --/>
<PointLight position=“0,1,0” diffuseColor=“white” />
<ImportedPrimitive3D xfile=“myFile.x” >

<ImportedPrimitive3D.OverridingMaterial>

<VisualMaterial>

<Button Text=“Press Me”
OnClick=“button_OnClick” />

</VisualMaterial>

</ImportedPrimitive3D.OverridingMaterial>

</ImportedPrimitive3D>

</Model3DGroup>

API for Viewport3D

The API specification for Viewport3D is as follows:

public class Viewport3D : UIElement // Control? FrameworkElement?
{

// Stock 2D properties
public BoxUnit Top { get; set; }
public BoxUnit Left { get; set; }
public BoxUnit Width { get; set; }
public BoxUnit Height { get; set; }
public Transform Transform { get; set; }
public Geometry Clip { get; set; }
// 3D scene-level properties
public Fog Fog { get; set }
public Camera Camera { get; set; } // have good default
// The 3D Model itself
public Model3D Model { get; set; }

}

This completes the Model3D API definitions in this embodiment of the invention.

Although the invention has been described in language specific to computer structural features, methodological acts and by computer readable media, it is to be understood that the invention defined in the appended claims is not necessarily limited to the specific structures, acts or media described. Therefore, the specific structural features, acts and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A computer data structure applied to computer program objects in a tree hierarchy for rendering three-dimensional (3D) models, the data structure comprising:
an object tree hierarchy for rendering a 3D scene;
a root object in the tree hierarchy collecting the objects for the 3D scene;
one or more group objects in the tree hierarchy collecting other group objects and leaf objects and having transforms operating on collected objects of the group object;
leaf objects in the tree hierarchy, leaf objects comprising
a light object in the tree hierarchy defining the illumination to be used in rendering a 3D model in the 3D scene; and
one or more draw 3D objects defining operations drawing a 3D model in the 3D scene.

2. The data structure of claim 1 further comprising:
camera data defining a camera eye point location in 3D space from which to view the 3D scene as a 2D image.

3. The data structure of claim 2 further comprising:
viewport data defining the boundaries of a 2D window viewing 2D image of the 3D scene.

4. The data structure of claim 1 further comprising:
the group object transforming the draw operations of the draw objects in the tree hierarchy to translate the 3D model in the 3D scene.

5. The data structure of claim 1 wherein a draw object further comprises:
one or more visual model objects executing the drawing operations to create a 2D image in the 3D scene.

6. A method for processing a hierarchy of computer program objects for drawing a two dimensional (2D) view of three-dimensional (3D) models rendered by a compositing system, the method comprising:
traversing branches of a 3D scene tree hierarchy of objects to process group objects and leaf objects of the tree;
detecting whether the next unprocessed object is a group object or a leaf object;
if a leaf object is detected, detecting if the leaf object is a light object or a drawing 3D object;
setting the illumination to be used by a drawing 3D object if the leaf object is a light object; and
drawing a 3D model as illuminated by the illumination provided by the light object if a drawing 3D object is detected.

7. The method of claim 6 further comprising:
setting a camera eye point; and
the act of drawing draws the 3D model based on the camera eye point.

8. The method of claim 6 further comprising:
collecting leaf objects in the 3D scene tree into a group of leaf objects; and
performing a group operation on the group of leaf objects.

9. The method of claim 8, wherein the group operation is one or more transform operations for transforming the drawing operations by the drawing objects in the group.

10. The method of claim 6 wherein the drawing object comprises:
a primitive 3D drawing object drawing a 3D model in the 3D scene.

11. The method of claim 6 wherein the drawing object comprises:
a model 3D drawing object drawing a 2D image in the 3D scene.

12. In a computing system an application program interface for creating a three-dimensional (3D) scene of 3D models defined by model 3D objects, said interface comprising:
one or more drawing objects defining instructions drawing 3D models of the 3D scene; and
a light object defining the illumination of the 3D models in the 3D scene.

13. The application program interface of claim 12 further comprising:
a group object collecting one or more drawing objects into a group for drawing a model that is a combination of the models drawn by the drawing objects in the group.

14. The application program interface of claim 13 wherein the group object contains one or more group operations acting on the drawing objects in the group.

15. The application program interface of claim 14 wherein the group operation comprises:
a transform that operates on the drawing operations of one or more of the drawing objects in the group.
